(19) United States
(12) Patent Application Publication
(10) Pub. No.: US 2014/0141288 A1
(43) Pub. Date: May 22, 2014

(54) BATTERY ASSEMBLY FOR VEHICLE AND VEHICLE HAVING THE SAME

(71) Applicants: HYUNDAI MOTOR COMPANY, Seoul (KR); KIA MOTORS CORPORATION, Seoul (KR)

(72) Inventors: Sang Jun Kim, Seoul (KR); Se Min Oh, Suwon (KR); Woo Yeol Jeong, Yongin (KR)

(73) Assignees: KIA MOTORS CORPORATION, Seoul (KR); HYUNDAI MOTOR COMPANY, Seoul (KR)

(21) Appl. No.: 13/837,795

(22) Filed: Mar. 15, 2013

(30) Foreign Application Priority Data
Nov. 16, 2012 (KR) 10-2012-0130256

(51) Int. Cl. H01M 10/50

(52) U.S. Cl. CPC H01M 10/5095; H01M 10/5026
USPC 429/7; 429/120

(57) ABSTRACT

A battery assembly for a vehicle and a vehicle having the battery assembly are provided. The battery assembly includes a battery housing in which air-conditioned air is introduced into a front thereof and is discharged from a rear thereof, a plurality of battery rows that are disposed in the battery housing so as to be perpendicular to a flow of the air-conditioned air, the battery rows forming through-holes through which the air-conditioned air flows, and being disposed in parallel to each other, one after another, from the front to the rear of the battery housing, and an internal duct that is disposed between a pair of adjacent battery rows among the battery rows having open front and rear end faces so that the air-conditioned air flows into the front end face through the rear end face.

### CROSS-REFERENCE TO RELATED APPLICATION

This application claims under 35 U.S.C. §119(a) the benefit of Korean Patent Application No. 10-2012-0130256 filed Nov. 16, 2012, the entire contents of which are incorporated herein by reference.

### BACKGROUND OF THE INVENTION

(a) Field of the Invention

The present invention relates to a battery assembly for a vehicle capable of effectively managing air-conditioned air and reducing a deviation in battery temperature distribution, and a vehicle having the same.

(b) Description of the Related Art

The present invention relates to a uniform, effective cooling structure of a high-capacity battery pack of a vehicle. To dispose the battery pack in a restricted space and to uniformly cool the battery pack, a temperature and flow of air on an inlet side should be constant, and air (high temperature) on an outlet side should not influence the air on the inlet side. To this end, it is desirable to optimize the structure of the battery pack for cooling, weight, and rigidity, and to precisely control the temperature of air flowing into rear battery pack modules using a thermoelectric module, thereby cooling cascaded battery pack modules with a small volume of air to the utmost, and contributing to improvement of fuel efficiency by reducing the weight.

A high-capacity battery pack for an electric vehicle conventionally is designed to dispose battery pack modules within a restricted layout in series in order to satisfy power performance, and thus fails to uniformly supply cooling air to each battery pack module. In particular, cold air passes through the battery pack modules adjacent to an inflow side of the cooling air, but hot air passes through the battery pack modules distant from the inflow side, so that a cooling effect is reduced. For example, assuming that the cooling air has a temperature of 35° C. at the inflow side and has an increment of 2° C. whenever passing through each battery pack module, a first battery pack module is supplied with the cooling air of 35° C., but a fourth battery pack module is supplied with the cooling air of 41° C. Thus, the cooling performance is remarkably reduced, and there are negative influences on the electrical properties, performance, and endurance of battery cells. As a result, a performance difference between the battery pack modules of the battery pack occurs, with the result being that the performance and endurance of the battery pack are also reduced.

In the related art disclosed in Korean Unexamined Patent Application Publication No. 10-2011-0073117, battery packs used in an online electric vehicle (called a “non-contact inductive charging electric vehicle”) can be effectively cooled in a high-temperature operating environment (e.g., summer season), and can be preheated and generate power from waste heat of the battery packs in a low-temperature operating environment (e.g., winter season). According to this reference, the online electric vehicle having the battery packs for supplying and storing power includes a thermoelectric module for converting heat generated from the battery pack into electric energy installed on the battery pack, and where a direct current (DC) power supply is connected to the thermoelectric module so as to supply DC power.

However, the above-described technology does not effectively deal with the air-conditioned air, but merely applies the thermoelectric module to conduct cooling/heating of the battery pack. The battery pack module is generally made up of six to ten cells. Mounting the thermoelectric module on the top of the battery pack module is problematic in that, due to cooling of only the top cell and heat collection, cooling of most of the other lower cells and heat collection are impossible.

Further, when only the top cell is cooled, there is a difference in a charging level due to a temperature difference between the cells. This may exert a serious and negative influence on the performance of the battery pack module, and thus reduces the performance of the battery pack module. In the case of a high-capacity battery pack, typically 10 to 16 battery pack modules are used. When the thermoelectric module is mounted on each module, the weight and expenses are increased, which can become a serious problem.

Thus, there is a need for a battery assembly that solves the problem of an inflow air temperature difference Δt between the battery pack modules in the cooling of an existing battery pack, and which would cause air to flow into each battery pack module at the same initial temperature and thus increase cooling performance and endurance of the battery pack modules, and a vehicle having the same.

The foregoing is intended merely to aid in the understanding of the background of the present invention, and is not intended to mean that the present invention falls within the purview of the related art that is already known to those skilled in the art.

### SUMMARY OF THE INVENTION

Accordingly, the present invention has been made keeping in mind the above problems occurring in the related art, and the present invention is intended to propose a battery assembly that solves a problem of an inflow air temperature difference Δt between battery pack modules in the cooling of an existing battery pack, thereby causing air to flow into each battery pack module at the same initial temperature and thus increase cooling performance and endurance of the battery pack modules, and a vehicle having the same.

In order to achieve the above object, according to an aspect of the present invention, there is provided a battery assembly for a vehicle, which includes: a battery housing in which air-conditioned air is introduced into a front thereof and is discharged from a rear thereof; a plurality of battery rows disposed in the battery housing so as to be perpendicular to a flow of the air-conditioned air, that form through-holes through which the air-conditioned air flows, and that are disposed in parallel to each other, one after another, from the front to the rear of the battery housing; and an internal duct disposed between a pair of adjacent battery rows among the battery rows, the internal duct having open front and rear end faces so that the air-conditioned air flows into the front end face through the rear end face, where the rear end face is disposed adjacent to a front end of the rear battery row, and the front end face is disposed adjacent to a rear end of the front battery row with a greater cross-sectional area than the rear end of the front battery row.

Here, lateral flow spaces through which the air-conditioned air flows may be formed between opposite ends of the battery rows and inner lateral walls of the battery housing, and opposite lateral edges of the front end face of the internal duct may be in close contact with the inner lateral walls of the battery housing so as to draw the air-conditioned air out of the lateral flow spaces.

Further, an upper flow space through which the air-conditioned air flows may be formed between upper surfaces of the battery rows and an inner upper wall of the battery housing, and an upper edge of the front end face of the internal duct may be in close contact with an inner upper wall of the battery housing so as to draw the air-conditioned air out of the upper flow space.

The battery housing may be configured so that a region in which the internal duct is installed is formed so as to be constricted by a reduced cross-sectional area.

The battery housing may be formed so that the region in which the internal duct is installed is constricted to enclose the internal duct.

The rear end face of the internal duct may be formed so as to have a cross-sectional area corresponding to that of the front end of the rear battery row; the front end face of the internal duct may be formed so as to have a greater cross-sectional area than the rear end of the front battery row; and the internal duct may be formed so as to be gradually reduced in cross-sectional area from the front toward the rear thereof.

The battery housing may be formed so that the region in which the internal duct is installed is constricted to enclose a circumference of the internal duct, and may have a shape in which a cross-sectional area thereof is gradually reduced from the front toward the rear thereof along with the internal duct.

According to another aspect of the present invention, there is provided a battery assembly for a vehicle, which includes: a battery housing in which air-conditioned air is introduced into a front thereof and is discharged from a rear thereof; a plurality of battery rows disposed in the battery housing so as to be perpendicular to a flow of the air-conditioned air, that form through-holes through which the air-conditioned air flows, and that are disposed in parallel to each other one after another from the front to the rear of the battery housing; an internal duct that is disposed between a pair of adjacent battery rows among the battery rows, the internal duct having open front and rear end faces so that the air-conditioned air flows into the front end face through the rear end face, where the rear end face is matched to and disposed adjacent to a front end of the rear battery row, and the front end face is disposed adjacent to a rear end of the front battery row with a greater cross-sectional area than the rear end of the front battery row; at least one thermoelectric module installed on a circumference of the internal duct, and having an air-conditioning face disposed so as to face toward the internal duct and a heat radiating face disposed so as to be face outward from the internal duct; and a control unit controlling the thermoelectric module so that a temperature difference between the plurality of battery rows is reduced.

Here, the internal duct may be formed of a metal material capable of conducting heat, and the air-conditioning face of the thermoelectric module is in surface contact with a circumference of the internal duct.

Further, the thermoelectric modules may be disposed on upper and lower walls of the internal duct so as to be spaced apart from each other.

According to yet another aspect of the present invention, there is provided a vehicle having a battery assembly that includes: a battery housing in which air-conditioned air is introduced into a front thereof and is discharged from a rear thereof; a plurality of battery rows disposed in the battery housing so as to be perpendicular to a flow of the air-conditioned air, that form through-holes through which the air-conditioned air flows, and that are disposed in parallel to each other one after another from the front to the rear of the battery housing; and an internal duct that is disposed between the a pair of adjacent battery rows among the battery rows, the internal duct having open front and rear end faces so that the air-conditioned air flows into the front end face through the rear end face, where the rear end face is disposed adjacent to a front end of the rear battery row, and the front end face is disposed adjacent to a rear end of the front battery row with a greater cross-sectional area than the rear end of the front battery row.

According to the battery assembly having the structure as described above and the vehicle having the same, the inflow air temperature difference Δt of the battery pack is removed, and thereby cooling air flows into each battery pack module at the same low temperature, and thus cooling performance and endurance of the battery modules are increased.

Further, to supply air of the same temperature to the battery modules located in the rear of a cooling air inlet, one aluminum tube preferably is used to provide an effect of reducing weight. Further, the battery housing can be embodied in a peanut structure so as to have an advantageous rigidity aspect thereof. Thus, a rigidity reinforcement can be removed to reduce weight.

In addition, a combination of the peanut structure and the cooling aluminum tube structure can be used to obtain an optimized structure for cooling using a flow of air caused by a pressure difference. Since the cooling temperature adjustment using rpm of an existing blower is not precise and thus has many disadvantages in the aspects of noise and vibration, an interior of the aluminum tube is formed as one channel as in a refrigerator, and thus there is an advantage in that the temperature of the air flowing into the battery assembly is directly controlled with precision by the thermoelectric modules.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a perspective view of a battery assembly for a vehicle according to an embodiment of the present invention;

FIG. 2 is a plan view of the battery assembly shown in FIG. 1;

FIG. 3 is a side view of the battery assembly shown in FIG. 1;

FIG. 4 is an enlarged view of an inner duct according to an embodiment of the present invention;

FIG. 5 is an enlarged view of the inner duct shown in FIG. 4;

FIG. 6 is an enlarged view of a thermoelectric module according to an embodiment of the present invention; and

FIG. 7 is a perspective view of a battery assembly for a vehicle according to another embodiment of the present invention.

### DETAILED DESCRIPTION OF THE INVENTION

Hereinafter, a battery assembly according to an exemplary embodiment of the present invention and a vehicle having the same will be described in detail with reference to the accompanying drawings

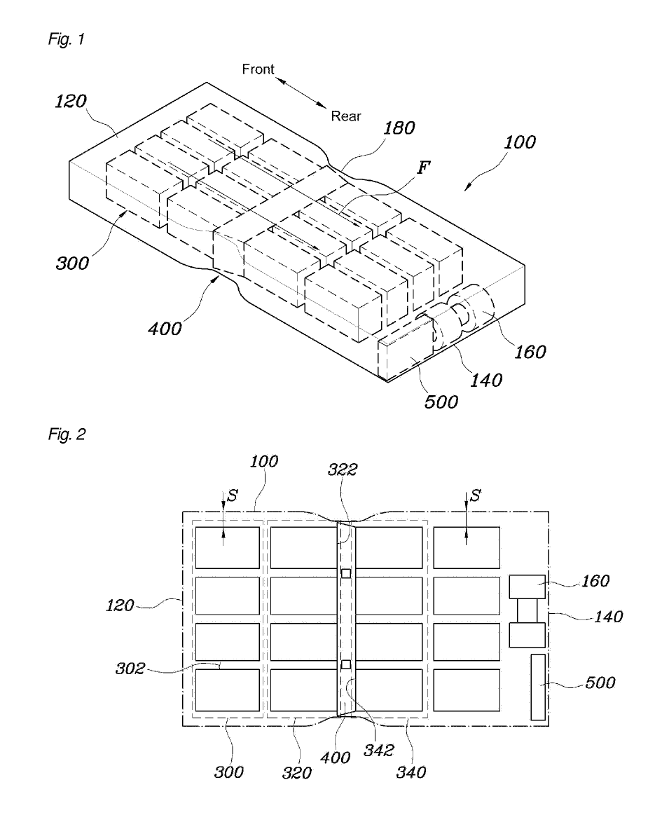

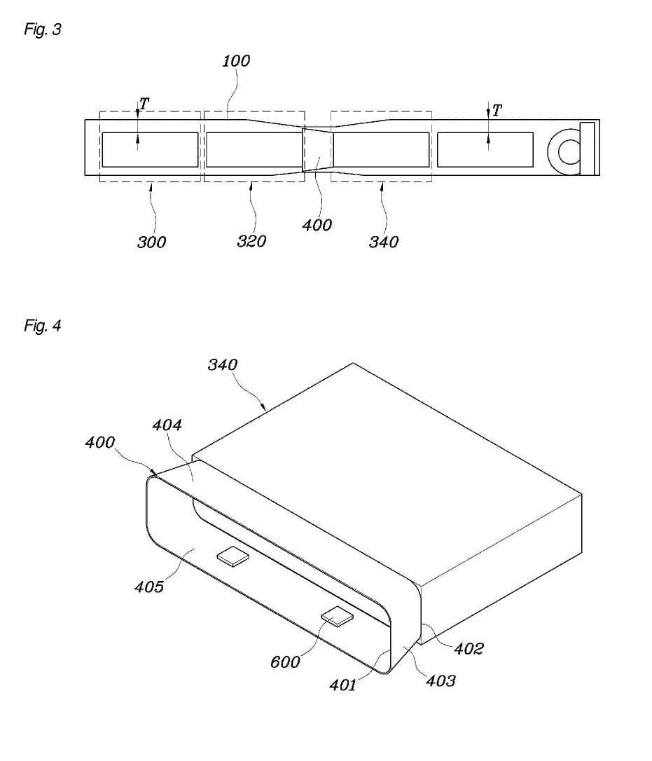

FIG. 1 is a perspective view of a battery assembly for a vehicle according to an embodiment of the present invention. FIG. 2 is a plan view of the battery assembly shown in FIG. 1, and FIG. 3 is a side view of the battery assembly shown in FIG. 1.

The battery assembly for a vehicle of the present invention includes: a battery housing 100 in which air-conditioned air F is introduced into the front thereof and is discharged from the rear thereof; a plurality of battery rows 300 disposed in the battery housing 100 so as to be perpendicular to a flow of the air-conditioned air F, form through-holes 302 through which the air-conditioned air F flows, and being disposed in parallel to each other, one after another, from the front to the rear of the battery housing; and an internal duct 400 between a pair of adjacent battery rows 320 and 340 among the battery rows 300, the internal duct 400 having open front and rear end faces 401 and 402 so that the air-conditioned air F flows into the front end face 401 through the rear end face 402, where the rear end face 402 is disposed adjacent to a front end 342 of the rear battery row 340, and the front end face 401 is disposed adjacent to a rear end 322 of the front battery row 320 with a greater cross-sectional area than the rear end 322 of the front battery row 320.

The battery assembly for a vehicle of the present invention may be applied to all kinds of vehicles that use a battery as a main driving source, such as electric vehicles, hybrid vehicles, and fuel cell vehicles.

The battery assembly, which may be designed for an eco-friendly vehicle, is configured so that the battery housing 100 is placed in a given space inside the vehicle, and batteries are connected in series and are disposed in the space. As shown, the air-conditioned air F is introduced into and discharged from the battery housing 100 for cooling. The air-conditioned air F is introduced in the front of the battery housing 100, and is discharged from the rear of the battery housing 100.

The battery rows 300 are housed in the battery housing 100. The battery rows 300 are arranged in parallel to each other, one after another, in such a manner that a plurality of battery packs are arranged in rows so as to be perpendicular to the flow of the air-conditioned air F. Thus, the foremost battery row is cooled by the air-conditioned air F in the beginning, and the rearmost battery row is cooled by the air-conditioned air F in the end.

The plurality of battery rows 300 are disposed in the battery housing 100 so as to be perpendicular to the flow of the air-conditioned air F, have through-holes 302 through which the air-conditioned air F flows, and being disposed in parallel to each other, one after another, from the front to the rear of the battery housing 100. The through-holes 302 are formed in each battery row 300 so that the air-conditioned air F can flow therethrough. The air-conditioned air F flows between the through-holes 302, and then cools the next battery row. Thus, according to this general structure, the cooling efficiency of the battery rows can be reduced in inverse proportion to a distance from the rear of the battery housing, and thus a temperature deviation between the battery rows is inevitable.

To solve this problem, the internal duct 400 is provided. The internal duct 400 is disposed between a pair of adjacent battery rows 320 and 340 among the battery rows 300. The front end face 401 and the rear end face 402 are open, and thus the air-conditioned air F is introduced into the front end face 401, and flows through the rear end face 402. Further, the rear end face 402 is disposed adjacent to the front end 342 of the battery row 340 located in the rear of the battery housing, whereas the front end face 401 is disposed adjacent to the rear end 322 of the battery row 320 located in the front of the battery housing with a greater cross-sectional area than the rear end 322 of the battery row 320. As a result, the air-conditioned air is introduced into the front large area and is discharged from the rear small area, and thus a discharging speed of the air-conditioned air is increased.

Simultaneously, the internal duct 400 draws the surrounding air-conditioned air failing to flow through the battery rows 300 in the battery housing 100 and collects and supplies the drawn air-conditioned air to the rear battery row 340, so that the air-conditioned air can be intensively discharged to the rear battery row 340 at a lower temperature. Due to this structure, the temperature deviation between the battery rows 300, particularly between the front battery row and the rear battery row, is reduced.

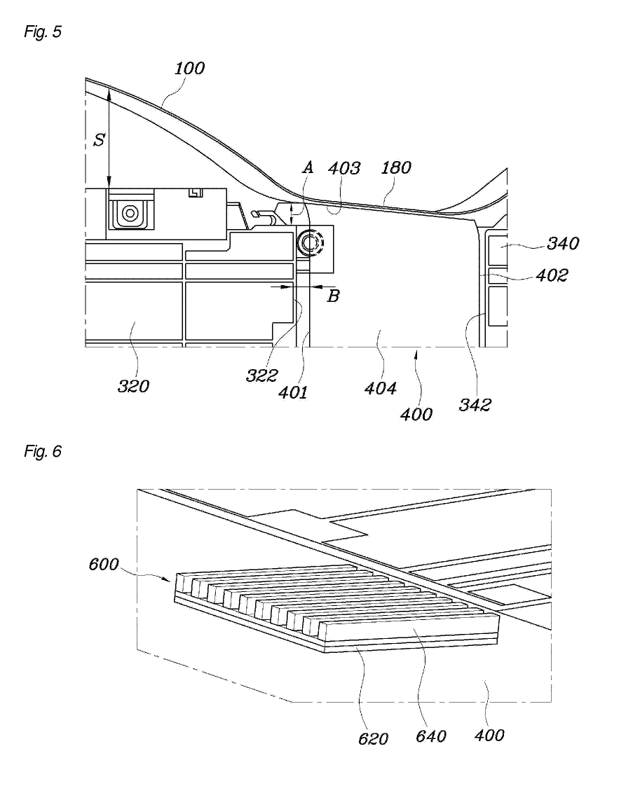

FIG. 3 is a side view of the battery assembly shown in FIG. 1. FIG. 4 is an enlarged view of an inner duct according to an embodiment of the present invention, and FIG. 5 is an enlarged view of the inner duct shown in FIG. 4.

Referring to FIGS. 3-5, lateral flow spaces S through which the air-conditioned air F flows are formed between opposite ends of the battery rows 300 and inner lateral walls of the battery housing 100. Thus, the air-conditioned air F introduced into the battery housing directly flows through the through-holes of each battery row, and can flow through the lateral flow spaces without flowing through the battery rows. Opposite lateral edges of the front end face 401 of the internal duct 400 are in close contact with the inner lateral walls of the battery housing 100, and thus the air-conditioned air F of the lateral flow spaces S is drawn. As a result, the air-conditioned air, which does not flow through the through-holes of the front battery row, is collected and supplied to the rear battery row, so that the air-conditioned air is supplied to the rear battery row at a lower temperature.

Further, an upper flow space T through which the air-conditioned air F flows is formed between upper surfaces of the battery rows 300 and an inner upper wall of the battery housing 100. An upper edge of the front end face 401 of the internal duct 400 is in close contact with the inner upper wall of the battery housing 100, and the air-conditioned air F of the upper flow space T is drawn, so that the air-conditioned air is also supplied to the rear battery row at a lower temperature.

The battery housing 100 is configured so that a region 180 in which the internal duct 400 is installed is formed so as to be constricted by a reduced cross-sectional area. That is, the battery housing 100 is formed so as to enclose the internal duct 400 by constricting the region 180 in which the internal duct 400 is installed.

Further, the rear end face 402 of the internal duct 400 is formed so as to have a cross-sectional area corresponding to that of the front end 342 of the rear battery row 340, and the front end face 401 of the internal duct 400 is formed so as to have a greater cross-sectional area than the rear end 322 of the front battery row 320. Thus, the internal duct 400 is formed so that a cross-sectional area thereof is reduced from the front toward the rear thereof. The battery housing 100 is formed so that the region 180 in which the internal duct 400 is installed is constricted to enclose a circumference of the internal duct 400, and thus has a shape in which the cross-sectional area thereof is reduced from the front toward the rear thereof along with the internal duct 400.

Therefore, the internal duct 400 collects air from the battery rows and their surroundings with a wide cross-sectional area, and discharges the air in a rearward direction. The rear end face 402 is exactly matched to the front end 342 of the rear battery row 340, and thereby supplies the air-conditioned air only to the battery rows. In this way, the internal duct 400 is formed so as to be constricted toward the rear in a funnel shape. Thus, the battery housing 100 is also formed so as to enclose the internal duct by constricting the region 180 in which the internal duct 400 is installed, and thereby allows the air-conditioned air to flow only to the internal duct 400 so as to maximize a cooling effect.

According to the present invention, a battery assembly for a vehicle may include: a battery housing 100 in which air-conditioned air F is introduced into the front thereof and is discharged from the rear thereof; a plurality of battery rows 300 disposed in the battery housing 100 so as to be perpendicular to a flow of the air-conditioned air F, form through-holes 302 through which the air-conditioned air F flows, and being disposed in parallel to each other, one after another, from the front to the rear of the battery housing; an internal duct 400 disposed between a pair of adjacent battery rows 320 and 340 among the battery rows 300, the internal duct 400 having open front and rear end faces 401 and 402 so that the air-conditioned air F flows into the front end face 401 through the rear end face 402, where the rear end face 402 is matched to and disposed adjacent to a front end 342 of the rear battery row 340, and the front end face 401 is disposed adjacent to a rear end 322 of the front battery row 320 with a greater cross-sectional area than the rear end 322 of the front battery row 320; at least one thermoelectric module 600 installed on a circumference of the internal duct 400, and has an air-conditioning face 620 disposed so as to face toward the internal duct 400 and a heat radiating face 640 disposed so as to face outward from the internal duct 400; and a control unit 500 controlling the thermoelectric module 600 so that a temperature difference between the plurality of battery rows 300 is reduced.

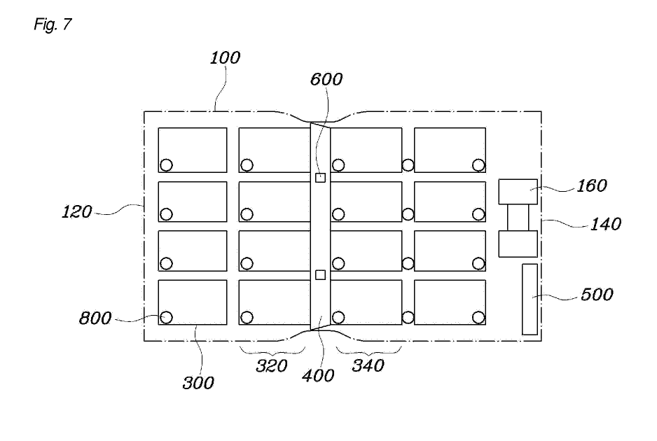

FIG. 6 is an enlarged view of a thermoelectric module according to an embodiment of the present invention, and FIG. 7 is a perspective view of a battery assembly for a vehicle according to another embodiment of the present invention.

In the embodiment depicted in FIG. 6, at least one thermoelectric module is installed on the internal duct. The thermoelectric module 600 is installed on a circumference of the internal duct 400, and is configured so that the air-conditioning face 620 is disposed so as to face toward the internal duct 400 and so that the heat radiating face 640 is disposed so as to face outward from the internal duct 400. The thermoelectric module uses the Peltier effect, and is allowed to perform cooling or heating on the air-conditioning face and heating or cooling on the heat radiating face, depending on the polarity of supplied electricity.

Further, the internal duct 400 is formed of a metal material capable of conducting heat. The air-conditioning face 620 of the thermoelectric module 600 is in surface contact with the circumference of the internal duct 400, and thereby the internal duct can be formed as a cooling duct. The control unit 500 controls the thermoelectric module 600 so that the temperature difference between the plurality of battery rows 300 is reduced. As a result, a temperature difference between the front battery row and the rear battery rows can be reduced.

Generally, the air-conditioned air cools the front battery row, and then the rear battery row. In the case of the rear battery row, the temperature of the air-conditioned air is high anyway, and thus a thermal unbalance may occur. Therefore, the air-conditioned air is again cooled in the internal duct 400, and then is supplied to the rear battery row. As a result, the temperature of the air-conditioned air supplied to the front battery row can be similar to that of the air-conditioned air supplied to the rear battery row.

Further, the thermoelectric modules 600 are disposed on upper and lower walls 404 and 405 of the internal duct 400 so as to be spaced apart from each other. Therefore, the thermoelectric modules can be selectively operated, and thus correct a temperature deviation between the front and rear battery rows as well as a temperature deviation between the left and right battery rows. To this end, a plurality of temperature sensors 800 are installed in the front of the respective battery packs of the battery rows, and temperatures thereof are checked by the control unit 500. The control unit 500 controls the operation of the thermoelectric modules, and as a result it is possible to achieve air-conditioning equalization.

A vehicle having a battery assembly according to the present invention may include: the battery housing 100 in which the air-conditioned air F is introduced into the front thereof and is discharged from the rear thereof; the plurality of battery rows 300 disposed in the battery housing 100 so as to be perpendicular to the flow of the air-conditioned air F, form the through-holes 302 through which the air-conditioned air F flows, and being disposed in parallel to each other, one after another, from the front to the rear of the battery housing; and the internal duct 400 disposed between the pair of adjacent battery rows 320 and 340 among the battery rows 300, the internal duct 400 having the open front and rear end faces 401 and 402 so that the air-conditioned air F flows into the front end face 401 through the rear end face 402, where the rear end face 402 is disposed adjacent to the front end 342 of the rear battery row 340, and the front end face 401 is disposed adjacent to the rear end 322 of the front battery row 320 with a greater cross-sectional area than the rear end 322 of the front battery row 320.

According to the battery assembly having the structure as described above and the vehicle having the same, the inflow air temperature difference Δt of the battery pack is removed, and as a result, cooling air flows into each battery pack module at the same low temperature, and thus cooling performance and endurance of the battery modules are increased.

To supply air of the same temperature to the battery modules located in the rear of a cooling air inlet, one aluminum tube preferably is used to provide an effect of reducing weight. Further, the battery housing can be embodied in a peanut structure so as to have an advantageous rigidity aspect thereof. Thus, a rigidity reinforcement can be removed to reduce weight.

Further, a combination of the peanut structure and the cooling aluminum tube structure can be used to obtain an optimized structure for cooling using a flow of air caused by a pressure difference. Since the cooling temperature adjustment using rpm of an existing blower is not precise and thus has many disadvantages in the aspects of noise and vibration, an interior of the aluminum tube preferably is formed as one channel as in a refrigerator, and thus there is an advantage in that the temperature of the air flowing into the battery assembly is directly controlled with precision by the thermoelectric modules.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A battery assembly for a vehicle comprising:
a battery housing in which air-conditioned air is introduced into a front thereof and is discharged from a rear thereof;
a plurality of battery rows disposed in the battery housing so as to be perpendicular to a flow of the air-conditioned air, form through-holes through which the air-conditioned air flows, and being disposed in parallel to each other, one after another, from the front to the rear of the battery housing; and
an internal duct disposed between a pair of adjacent battery rows among the battery rows, the internal duct having open front and rear end faces so that the air-conditioned air flows into the front end face through the rear end face, wherein the rear end face is disposed adjacent to a front end of the rear battery row, and the front end face is disposed adjacent to a rear end of the front battery row with a greater cross-sectional area than the rear end of the front battery row.

2. The battery assembly according to claim 1, wherein lateral flow spaces through which the air-conditioned air (F) flows are formed between opposite ends of the battery rows and inner lateral walls of the battery housing, and opposite lateral edges of the front end face of the internal duct are in close contact with the inner lateral walls of the battery housing so as to draw the air-conditioned air out of the lateral flow spaces.

3. The battery assembly according to claim 1, wherein an upper flow space through which the air-conditioned air flows is formed between upper surfaces of the battery rows and an inner upper wall of the battery housing, and an upper edge of the front end face of the internal duct is in close contact with an inner upper wall of the battery housing so as to draw the air-conditioned air out of the upper flow space.

4. The battery assembly according to claim 1, wherein the battery housing is configured so that a region in which the internal duct is installed is formed so as to be constricted by a reduced cross-sectional area.

5. The battery assembly according to claim 1, wherein the battery housing is formed so that a region in which the internal duct is installed is constricted to enclose the internal duct.

6. The battery assembly according to claim 1, wherein: the rear end face of the internal duct is formed so as to have a cross-sectional area corresponding to that of the front end of the rear battery row; the front end face of the internal duct is formed so as to have a greater cross-sectional area than the rear end of the front battery row; and the internal duct is formed so as to be gradually reduced in cross-sectional area from the front toward the rear thereof.

7. The battery assembly according to claim 6, wherein the battery housing is formed so that a region in which the internal duct is installed is constricted to enclose a circumference of the internal duct, and has a shape in which a cross-sectional area thereof is gradually reduced from the front toward the rear thereof along with the internal duct

8. A battery assembly for a vehicle comprising:
a battery housing in which air-conditioned air is introduced into a front thereof and is discharged from a rear thereof;
a plurality of battery rows disposed in the battery housing so as to be perpendicular to a flow of the air-conditioned air, form through-holes through which the air-conditioned air flows, and being disposed in parallel to each other, one after another, from the front to the rear of the battery housing;
an internal duct disposed between the a pair of adjacent battery rows among the battery rows, has open front and rear end faces so that the air-conditioned air flows into the front end face through the rear end face, wherein the rear end face is matched to and disposed adjacent to a front end of the rear battery row, and the front end face is disposed adjacent to a rear end of the front battery row with a greater cross-sectional area than the rear end of the front battery row;
at least one thermoelectric module installed on a circumference of the internal duct, and having an air-conditioning face disposed so as to face toward the internal duct and a heat radiating face disposed so as to face outward from the internal duct; and
a control unit controlling the thermoelectric module so that a temperature difference between the plurality of battery rows is reduced.

9. The battery assembly according to claim 8, wherein the internal duct is formed of a metal material capable of conducting heat, and the air-conditioning face of the thermoelectric module is in surface contact with a circumference of the internal duct.

10. The battery assembly according to claim 8, wherein the thermoelectric modules are disposed on upper and lower walls of the internal duct so as to be spaced apart from each other.

11. A vehicle having a battery assembly that comprises:
a battery housing in which air-conditioned air is introduced into a front thereof and is discharged from a rear thereof;
a plurality of battery rows disposed in the battery housing so as to be perpendicular to a flow of the air-conditioned air, form through-holes through which the air-conditioned air flows, and being disposed in parallel to each other, one after another, from the front to the rear of the battery housing; and
an internal duct disposed between the a pair of adjacent battery rows among the battery rows, the internal duct having open front and rear end faces o that the air-conditioned air flows into the front end face through the rear end face, wherein the rear end face is disposed adjacent to a front end of the rear battery row, and the front end face is disposed adjacent to a rear end of the front battery row with a greater cross-sectional area than the rear end of the front battery row.
